(19) United States
(12) Patent Application Publication
(10) Pub. No.: US 2007/0028522 A1
(43) Pub. Date: Feb. 8, 2007

(54) Fuel reformer

(75) Inventors: Minoru Mizusawa, Tokyo (JP); Sakae Chijiiwa, Tokyo (JP); Masato Tamura, Tokyo (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Ishikawajima-Harima Heavy Industries Co., Ltd., Tokyo (JP)

(21) Appl. No.: 10/556,682

(22) PCT Filed: Feb. 12, 2004
(86) PCT No.: PCT/JP04/01445

§ 371 Date: Nov. 14, 2005

(51) Int. Cl. B01J 8/00

(52) U.S. Cl. 48/127.9

(57) ABSTRACT

Provided is a fuel reforming apparatus wherein vacuum reforming tubes (13) are accommodated in a flow path (12) between an inner cylinder (9a) of a heat-insulating vessel (9) and a furnace flue (11) arranged in the inner cylinder (9a). Formed between the furnace flue (11) and a guide cylinder (21) accommodated in the furnace flue (11) is a gap though which combustion gas (28) generated in a combustor (10) is raised. A helical plate (22) is arranged in the flow path (12) such that the combustion gas (28) lowered in the flow path (12) flows across the reforming tubes (13). Thus, red heating of the furnace flue can be sufficiently conducted to sufficiently heat the reforming tubes through radiation heat transfer. As a result, heat transfer areas of the reforming tubes may be made smaller to reduce in size the reforming tubes. Since upper ends of the reforming tubes are not exposed to high temperature and the combustion gas lowered between the inner cylinder of the vessel and the furnace flue has no deflections in flow, heat inputs to the respective reforming tubes become uniform, leading to improvement in performance of and reduction in size of the reformer.

### TECHNICAL FIELD

The present invention relates to a fuel reforming apparatus.

### BACKGROUND ART

In general, a fuel cell is such that, inversely to electrolysis of water, hydrogen is coupled with oxygen and electricity and heat generated thereupon are taken out. Because of their higher electricity generation efficiency and adaptability to environment, fuel cells have been actively developed for household-fuel-cell cogeneration systems and fuel-cell-powered automobiles. Hydrogen as fuel for such fuel cells is produced by reforming, for example, petroleum fuel such as naphtha or kerosene or city gas through a reformer.

FIG. 1 shows a whole system for a residential type polymer electrolyte fuel cell (PEFC) as an example of an installation with a reformer in which reference numeral 1 denotes a reformer; 2, a water vaporizer to vaporize water into water vapor through heat of exhaust gas from the reformer 1; 3, a primary fuel gasifier to gasify primary fuel such as naphtha through heat of the exhaust gas; 4, a desulfurizer to desulfurize source gas to be fed to the reformer 1; 5, a low-temperature shift converter to lower the reformed gas from the reformer 1 to a required temperature (approximately 200-250° C. or so) through cooling water so as to change CO and H₂O into CO₂ and H₂; 6, a selective oxidation CO remover which removes CO by an oxidation reaction from reformed gas passed through the shift converter 5 controlled by cooling water; 7, a humidifier to humidify the reformed gas having passed through the CO remover 6; and 8, a PEFC with a cathode 8a and an anode 8b.

In the installation shown in FIG. 1, water is vaporized by the vaporizer 2 into water vapor while primary fuel such as naphtha is gasified by the gasifier 3 into source gas. The source gas mixed with the water vapor is guided to the desulfurizer 4, and the source gas desulfurized in the desulfurizer 4 is guided to the reformer 1. The gas reformed by the reformer 1 is guided via the shift converter 5, CO remover 6 and humidifier 7 to the anode 8b of PEFC 8 while the air is guided through the humidifier 7 to the cathode 8a of the PEFC 8, thereby generating electric power. Anode off-gas from the anode 8b is re-utilized as fuel gas in the reformer 1 while the water from the cathode 8a is utilized as cooling water for the PEFC 8, CO remover 6 and shift converter 5 and as part of the water vapor to be mixed with the source gas.

Conventionally, the reformer 1 and its associated instruments or the vaporizer 2, gasifier 3, desulfurizer 4, shift converter 5 and CO remover 6 are assembled as a unit into a fuel reforming apparatus. As such fuel reforming apparatus, for example, a burner combustion type apparatus as disclosed in JP 2003-327405 A has been proposed.

Such fuel reforming apparatus is shown in FIGS. 2 and 3 in which parts similar to those shown in FIG. 1 are designated by the same reference numerals. In the fuel reforming apparatus shown in FIGS. 2 and 3, the unit of the reformer 1 with its associated instruments (the vaporizer 2, gasifier 3, desulfurizer 4, shift converter 5 and CO remover 6) is covered with and enclosed by a vacuum heat-insulating vessel 9 with inner and outer cylinders 9a and 9b and a vacuum heat-insulating layer 9c between them, thereby providing the fuel reforming apparatus.

In the above-mentioned burner combustion type apparatus, the inner cylinder 9a itself of the vessel 9 is utilized as a part of the reformer 1, and a furnace flue 11 is arranged centrally inside the inner cylinder 9a for flow of the combustion gas from a combustor 10 therethrough; formed between the furnace flue 11 and the inner cylinder 9a is a flow path 12 of the combustion gas in which a plurality of (six in FIG. 3) reforming tubes 13 are arranged side by side and are charged with reforming catalysts (not shown) through which source gas flows for reforming thereof, thereby providing the reformer 1. Each of the reforming tubes 13 is of a double-walled tube structure with inner and outer tubes 13a and 13b such that the source gas is raised up in a space between the tubes 13a and 13b for heat exchange with the combustion gas, is returned back at upper ends of the tubes and is lowered in a space inside the inner tube 13a.

The furnace flue 11 of the reformer 1 is connected to an upper end of a base inner cylinder 16 standing from a base plate 14. A lower end of the vessel 9 is detachably and sealingly connected, via connecting means (not shown) such as bolts and nuts, to an upper end of a base outer cylinder 15 short in length and standing from an outer periphery of the base plate 14. The associated instruments of the reformer 1 or the vaporizer 2, gasifier 3, desulfurizer 4, shift converter 5 and CO remover 6 are arranged in a cylindrical space 17 which is defined by the base plate 14, the base inner and outer cylinders 16 and 15 and the inner cylinder 9a of the vessel 9 and which is communicated with the flow path 12 of the combustion gas.

The base inner cylinder 16 is interiorly formed with an air flow path 18 to feed air to the combustor 10. Arranged axially of the cylinder is a fuel gas supply pipe 19 to feed fuel gas such as anode off gas to the combustor 10. Upon startup, a combustion-fuel supply pipe 20 is adapted to feed fuel for combustion to the combustor 10.

In the fuel reforming apparatus shown in FIG. 2, the construction work of the heat insulating layer 9c is completed merely by enclosing the unit with the vacuum heat-insulating vessel 9. As a result, time and labor for the construction work of the heat insulating layer 9c are drastically relieved. Moreover, whenever maintenance such as replacement of catalysts in the reformer 1 or inspection is to be conducted, merely opening the vessel 9 will suffice, leading to prompt operation.

Use of the vessel 9 having the vacuum heat-insulating layer 9c between the inner and outer cylinders 9a and 9b remarkably enhances the heat insulating performance so that decrease in volume of the heat insulating layer 9c can be attained and the apparatus can be made compact in size while heat dissipation is suppressed to improve thermal efficiency.

The interior of the inner cylinder 9a of the vessel 9 is utilized as the flow path 12 of the combustion gas for the reformer 1, which brings about simplification in structure of the whole apparatus and thus reduction in cost. The reformer 1 comprises the furnace flue 11 having combustion gas from the combustor 10 flowing therethrough and the plural reforming tubes 13 arranged side by side in the flow path 12 of the combustion gas between the furnace flue 11 and the inner cylinder 9a of the vessel 9 and having reforming catalysts charged therein for flowing of the source gas therethrough for reforming thereof, which makes it possible to shorten in length the reformer 1 through utilization of the multiple reforming tubes 13 and utilization of radiant heat transfer due to high-temperature combustion in the combustor 10, with the advantageous result that the associated instruments such as the vaporizer 2, gasifier 3, desulfurizer 4, shift converter 5 and CO remover 6 can be arranged beneath the reformer 1 so as to decrease in height the fuel reforming apparatus.

In a normal operation, the reformer 1 is fed with the primary fuel; the combustion gas from the burnt fuel gas is heat exchanged with the primary fuel in the reformer 1, vaporizer 2 and gasifier 3 and is lowered in temperature into about 200° C. or temperature level of reaction in the shift converter 5 and in the CO remover 6, so that there is no fear of unnecessary heat exchange occurring even in an instance where reactors such as the shift converter 5 and the CO remover 6 are nakedly arranged in the cylindrical space 17 which is the flow path of the combustion gas.

Thus, reduction in size of the apparatus and increase in heat efficiency can be attained; labor and time of the construction work for the heat insulating layer 9c can be drastically reduced; and maintenance can be readily carried out.

As mentioned above, the burner combustion type reforming apparatus shown in FIGS. 2 and 3 has various excellent advantages. However, the combustion gas is raised up through the furnace flue 11 with a greater sectional area so that the furnace flue 11 cannot be sufficiently red heated through convective heat transfer, failing to efficiently conduct radiation heat transfer to the reforming tubes 13. Therefore, the reforming tubes 13 must have increased surface areas (heat transfer areas) and cannot be made sufficiently compact in size.

The combustion gas is not sufficiently decreased in temperature even when it reaches an upper end of the furnace flue 11. Therefore, the combustion gas, which is returned back at the upper end of the furnace flue 11 into the flow path between the furnace flue 11 and the inner cylinder 9a of the vessel 9, is high in temperature so that upper ends of the reforming tubes 13 arranged in the flow path between the inner cylinder 9a and the furnace flue 11 are exposed to high temperature. Therefore, the reforming tubes must be made from heat-resisting alloy, leading to increase in cost.

Moreover, the combustion gas lowered in the flow path between the furnace flue 11 and the inner cylinder 9a of the vessel 9 flows right down along the reforming tubes 13 so that it has less heat transfer efficiency and may have deflections in flow; as a result, heat inputs of the respective reforming tubes 13 may become nonuniform, leading to lowered performance of the reformer 1 and difficulty in sufficiently reducing in size of the reforming tubes 13.

The invention was made in view of the above and has its object to provide a fuel reforming apparatus which facilitates convective heat transfer by the combustion gas flowing in the furnace flue so as to sufficiently red heat the furnace flue and sufficiently heat the reforming tubes through the radiation heat transfer, so that the heat transfer area of each of the reforming tubes may be made smaller to further reduce in size the reforming tubes; the upper end of the reforming tube may be prevented from being exposed to high temperature so as to allow the reforming tubes made from material other than heat-resisting alloy; the combustion gas flowing down through the flow path between the furnace flue and the inner cylinder of the vacuum heat-insulating vessel is prevented from having deflections in flow; heat inputs of the respective reforming tubes are made uniform, whereby the reformer can be improved in performance and reduced further in size.

### SUMMARY OF THE INVENTION

The invention is directed to a fuel reforming apparatus wherein reforming tubes are accommodated in a flow path between an inner cylinder of a vessel and a furnace flue arranged in the inner cylinder, combustion gas generated in a combustor and raised up in said furnace flue being lowered in said flow path so as to reform source gas flowing in a reformer, characterized in that formed between said furnace flue and a guide cylinder accommodated in the furnace flue is a gap though which the combustion gas generated in the combustor for introduction toward an upper end of said flow path is raised.

The invention is further directed to a fuel reforming apparatus wherein reforming tubes are accommodated in a flow path between an inner cylinder of a vessel and a furnace flue arranged in said inner cylinder, combustion gas generated in a combustor and raised up in said furnace flue being lowered in said flow path so as to reform source gas flowing in a reformer, characterized in that a helical plate is arranged in said flow path such that the combustion gas returned back at an upper end of said furnace flue and lowered in said flow path flows across said reforming tubes.

The invention is still further directed to a fuel reforming apparatus wherein reforming tubes are accommodated in a flow path formed between an inner cylinder of a vessel and a furnace flue arranged in said inner cylinder, combustion gas generated in a combustor and raised up in said furnace flue being lowered in said flow path so as to reform source gas flowing in a reformer, characterized in that formed between said furnace flue and a guide cylinder accommodated in the furnace flue is a gap through which the combustion gas generated in the combustor for introduction toward an upper end of said flow path is raised, a helical plate being arranged in said flow path such that the combustion gas returned back at an upper end of said furnace flue and lowered in said flow path flows across said reforming tubes.

In the invention, the combustion gas is raised through the gap between the furnace flue and the guide cylinder accommodated in the furnace flue to red heat the furnace flue through convective heat transfer, the combustion gas being returned back at the upper end of the furnace flue and lowered while guided by the helical plate arranged in the flow path defined by the inner cylinder and the furnace flue. Thus, the reforming tubes are heated through radiation heat transfer of the furnace flue and are also heated through convective heat transfer of the combustion gas which is lowered to flow across the reforming tubes by the guidance of the helical plate.

According to a fuel reforming apparatus of the invention, combustion gas is raised up in the narrow gap between the furnace flue and the guide cylinder and in parallel with the source gas flowing in the reforming tubes so as to red heat the furnace flue, whereby radiation heat transfer can be efficiently conducted from the furnace flue to the reforming tubes. Thus, the surface areas (heat transfer areas) of the reforming tubes can be reduced and the reforming tubes can be made compact in size.

Because of the reforming tubes being not exposed to high temperature, the reforming tubes may be made from usual stainless steel, leading to decrease in cost.

The combustion gas lowered in the space between the furnace flue and the inner cylinder of the vacuum heat-insulating vessel is guided by the helical plate to flow diametrically across all of the reforming tubes, so that flow rate of the combustion gas is high in comparison with an instance where the combustion gas flows right down with no helical plate, thereby obtaining heat transfer efficiency about four times as great as that of latter. Thus, the convective heat transfer is facilitated; heat transfer is made to all of the reforming tubes with uniform gas flow rate so that heat inputs to the respective reforming tubes become uniform, resulting in lack of heat unevenness; thus, the reformer can obtain high reforming performance and the reforming tubes may be compact in size.

### BRIEF DESCRIPTION OF DRAWINGS

FIG. 1 is a view showing a whole system of an example of an installation with a reformer;

FIG. 2 is a vertical section of an example of a burner combustion type fuel reforming apparatus;

FIG. 3 is a view looking in the direction of arrows III in FIG. 2;

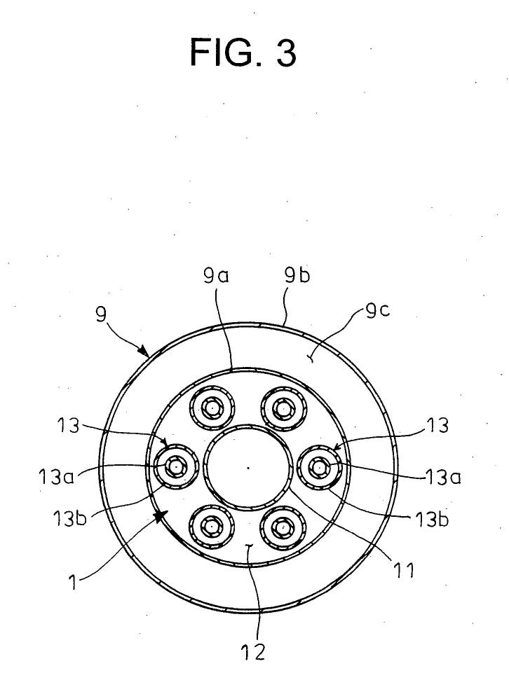

FIG. 4 is a vertical section of an embodiment of a fuel reforming apparatus according to the invention; and

FIG. 5 is a view looking in the direction of arrows V in FIG. 4.

### BEST MODE FOR CARRYING OUT THE INVENTION

An embodiment of the invention will be described on the basis of the drawings.

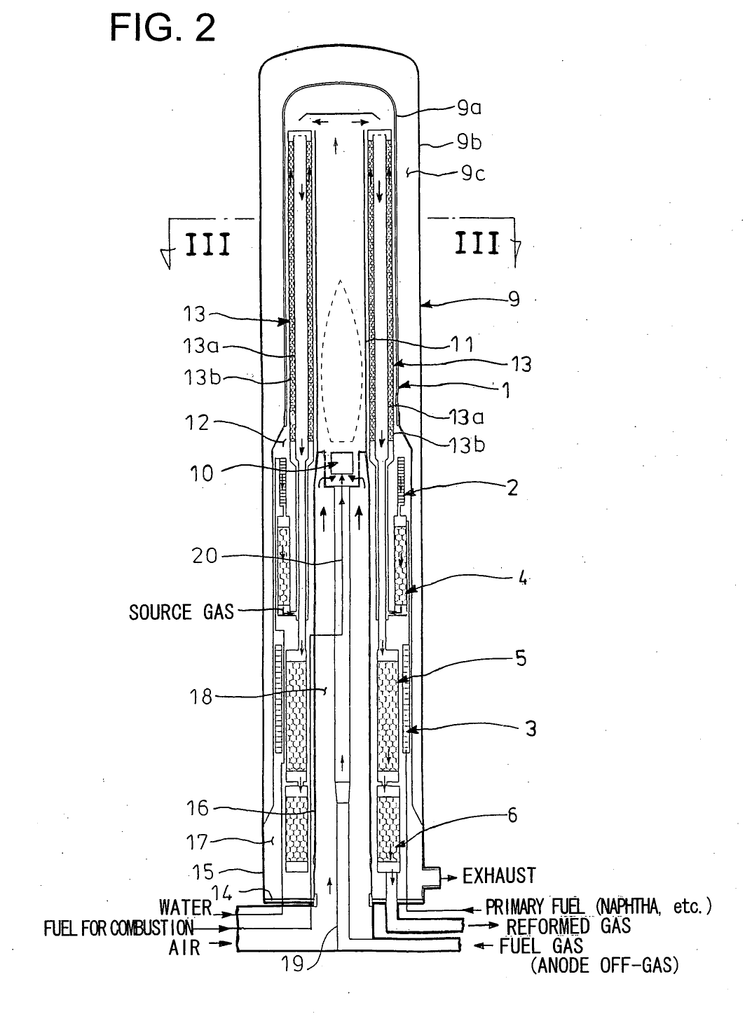

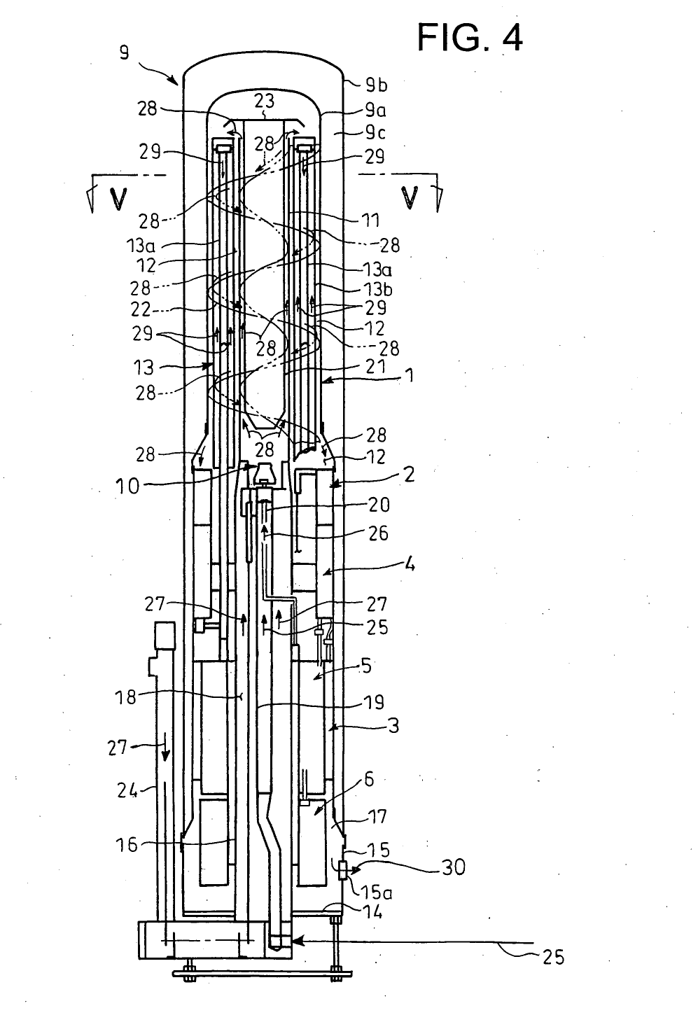

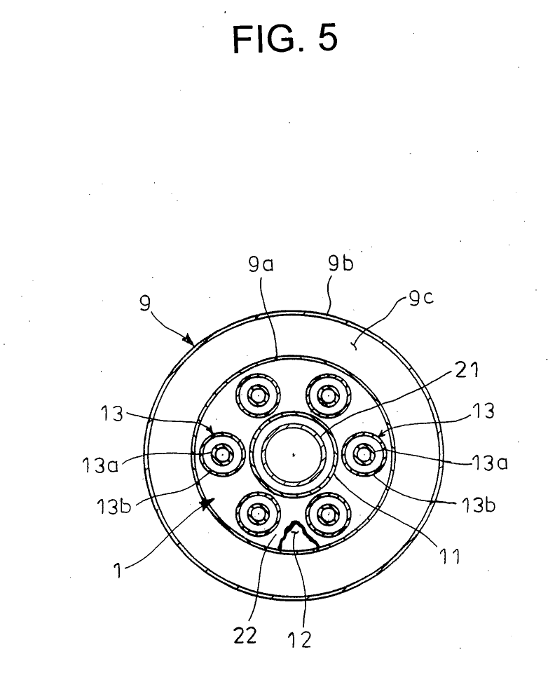

FIGS. 4 and 5 illustrate an embodiment of the invention in which parts similar to those in FIG. 2 are represented by the same reference numerals. A fuel reforming apparatus according to the embodiment, which is similar in fundamental structure to the conventional apparatus shown in FIG. 2, is characteristic in that, as shown in FIG. 4, a guide cylinder 21 is arranged coaxially of and extends through a furnace flue 11 beyond an upper end of the furnace flue 11 and that a helical plate 22 is arranged in a flow path 12 defined by the furnace flue 11 and an inner cylinder 9a of a vacuum heat-insulating vessel 9 so as to surround reforming tubes 13.

The guide cylinder 21 is made from usual stainless steel, is hollow in its interior and is closed at its lower end. Mounted on an upper end of the guide cylinder 21 is a guide plate 23 which is larger in diameter than the furnace flue 11; combustion gas raised up in a gap between the furnace flue 11 and the guide cylinder 21 is returned back by the guide of guide plate 23 into the flow path 12 between the inner cylinder 9a and the furnace flue 11.

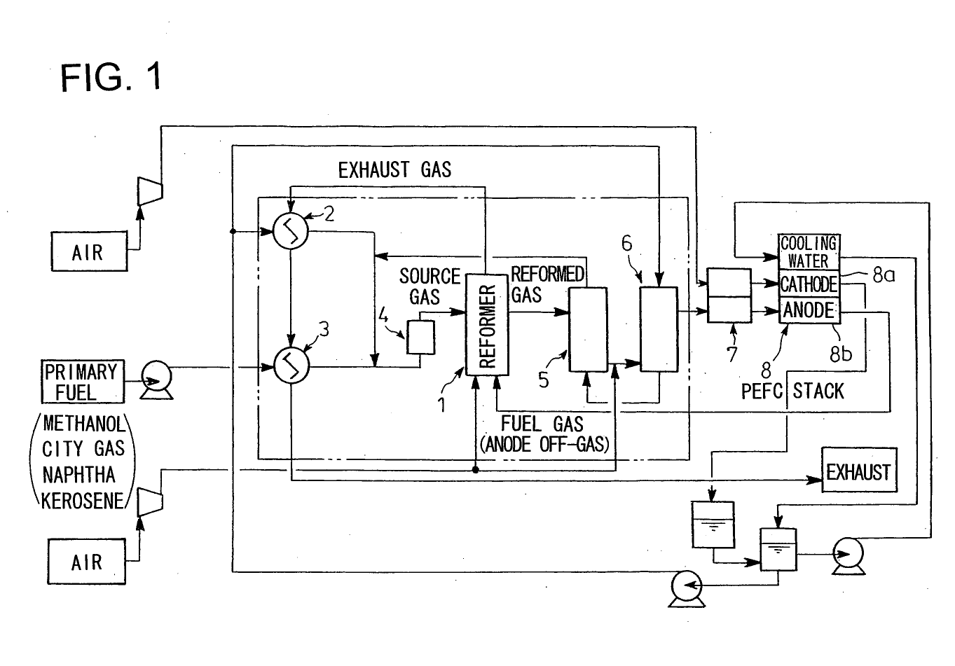

In the drawings, reference numeral 15a denotes a discharge port connected to a side of the base outer cylinder 15; 24, an air supply pipe; 25, fuel gas which is anode off-gas; 26, combustion fuel such as naphtha; 27, air; 28, combustion gas; 29, source gas which is being reformed; and 30, exhaust gas. Though not shown, the primary fuel such as naphtha is adapted to be introduced into the primary fuel gasifier 3; water is adapted to be introduced into a water vaporizer 2; and the reformed gas is adapted to be introduced via a selective oxidation CO remover 6 and a humidifier 7 shown in FIG. 1 into an anode 8b of a PEFC 8.

Next, the mode of operation of the above embodiment will be described also in conjunction with FIG. 1.

When electric power is to be generated in the PEFC 8 shown in FIG. 1, primary fuel is required to be reformed by a reformer 1. To this end, in the fuel reforming apparatus shown in FIG. 4, water is vaporized in the vaporizer 2 into water steam and the primary fuel such as naphtha is gasified in the gasifier 3 into source gas. The source gas mixed with the water steam is introduced into the desulfurizer 4. After desulfurized in the desulfurizer 4, the source gas 29 is guided and raised up between outer and inner tubes 13b and 13a of reforming tubes 13 in the reformer 1, is returned back at the upper ends of the reforming tubes 13 and is lowered in the inner tube 13a; during such upward and downward movements, as detailedly explained hereinafter, it is heated by the combustion gas 28 so as to be reformed.

On the other hand, the fuel gas 25, the combustion fuel 26 and the air from the air supply pipe 24 are burnt in the combustor 10 to generate high-temperature (about 1200° C.) combustion gas 28 which is raised up in the narrow gap between the furnace flue 11 and the guide cylinder 21 uniformly and at high flow rate without having deflections in flow. The upward flow of the combustion gas 28 is in parallel with the source gas 29 flowing upward or downward in the reforming tubes 13. Thus, the upward flow of the combustion gas 28 in the narrow gap between the furnace flue 11 and the guide cylinder 21 and in parallel with the source gas 29 flowing in the reforming tubes 13 accelerates convective heat transfer by the combustion gas 28 to red heat the furnace flue 11, the reforming tubes 13 being heated by radiation heat transfer of the furnace flue 11.

The combustion gas 28 having reached the upper end of the narrow gap between the furnace flue 11 and the guide cylinder 21 is returned back by the guide plate 23 and is lowered in the flow path 12 between the inner cylinder 9a and the furnace flue 11 helically along the helical plate 22 to flow diametrically across the reforming tubes 13 and heat the same through convective heat transfer; then, it passes through the cylindrical space 17 where the vaporizer 2, desulfurizer 4, shift converter 5, gasifier 3 and CO remover 6 are accommodated and is discharged outside as the exhaust gas 30 via the combustion gas discharge port 15a on the lower end of the base outer cylinder 15.

The source gas 29 flowing up and down in the reforming tubes 13 is heated through radiation heat transfer of the furnace flue 11 heated by the combustion gas 28 and is also heated through convective heat transfer of the combustion gas 28 which is lowered to flow diametrically across the reforming tubes 13 helically along the helical plate 22 in the flow path 12 between the inner cylinder 9a and furnace flue 11, whereby it is reformed.

According to the embodiment, the combustion gas 28 is raised up in the narrow gap between the furnace flue 11 and the guide cylinder 21 and in parallel with the source gas 29 flowing in the reforming tubes 13 so as to red heat the furnace flue 11 through convective heat transfer, so that efficient radiation heat transfer can be conducted to the reforming tubes 13 by the furnace flue 11. Therefore, the surface areas (heat transfer areas) of the reforming tubes 13 can be reduced and the reforming tubes 13 can be made compact in size in comparison with those in the fuel reforming apparatus shown in FIG. 2.

The combustion gas 28 heats the furnace flue 11 through convective heat transfer, and the furnace flue 11h heats through radiation heat transfer a low-temperature region with great heat input required which is adjacent to an inlet of the reformer 1 below a lower end of the furnace flue 11, so that temperature of the combustion gas 28 at the upper end of the gap between the furnace flue 11 and the guide cylinder 21 is lowered than the combustion temperature (1200° C.) of the combustor 10 into the order of 800° C. which is sufficient for reforming. Therefore, the reforming tubes 13 may not be made from costly heat-resisting alloy and may be made from usual stainless steel, leading to cost-down of the fuel reforming apparatus.

The combustion gas 28 lowered in the flow path 12 between the inner cylinder 9a of the vessel 9 and the furnace flue 11 is guided by the helical plate 22 to flow diametrically across all the reforming tubes 13 so that the flow rate of the combustion gas 28 is high in comparison with an instance where the combustion gas flows right down with no helical plate 22, so that great heat transfer efficiency is obtained which is about four times as great as that of the latter. Thus, convective heat transfer is facilitated and is made to all of the reforming tubes 13 at uniform gas flow rate, so that input heats of the respective reforming tubes 13 become uniform with no heat unevenness. As a result, the reformer 1 can obtain high reforming performance. Moreover, the reforming tubes 13 have great heat transfer efficiency, which fact also contributes to reduction in size of the reforming tubes 13.

The gas reformed in the reformer 1 passes through the low-temperature shift converter 5 and the selective oxidation CO remover 6 and is fed via the lower end of the base outer cylinder 15 to outside of the fuel reforming apparatus and then into the humidifier 7 shown in FIG. 1; it further introduced via the humidifier 7 to the anode 8b of the PEFC 8 while the air is introduced via the humidifier 7 to the cathode 8a of the PEFC 8, thereby generating electricity.

It is to be understood that, in a fuel reforming apparatus according to the invention, various changes and modifications may be effected without departing from the spirit of the invention. For example, the selective oxidation CO remover may be substituted with a methanator which utilizes so-called methanation reaction.

### INDUSTRIAL APPLICABILITY

As is clear from the foregoing, a fuel reforming apparatus according to the invention is effective as a fuel reforming apparatus for reforming the primary fuel such as methanol, city gas, naphtha or kerosene to be fed to the fuel cell. Since surface areas (heat transfer areas) of respective reforming tubes can be reduced, the apparatus is especially effective as a fuel reforming apparatus which can be made compact in size; it is effective as a fuel reforming apparatus which is low in cost; furthermore, it is effective as fuel reforming apparatus which can obtain high reforming performance as convective heat transfer is facilitated and conducted to all of the reforming tubes with uniform gas flow rate so that input heats of the respective reforming tubes become uniform with heat unevenness being eliminated.

1. A fuel reforming apparatus wherein reforming tubes are accommodated in a flow path between an inner cylinder of a vessel and a furnace flue arranged in said inner cylinder, combustion gas generated in a combustor and raised up in said furnace flue being lowered in said flow path so as to reform source gas flowing in a reformer, characterized in that formed between said furnace flue and a guide cylinder accommodated in the furnace flue is a gap through which the combustion gas generated in the combustor for introduction toward an upper end of said flow path is raised.

2. A fuel reforming apparatus wherein vessel wherein reforming tubes are accommodated in a flow path between an inner cylinder of a vessel and a furnace flue arranged in said inner cylinder, combustion gas generated in a combustor and raised up in said furnace flue being lowered in said flow path so as to reform source gas flowing in a reformer, characterized in that a helical plate is arranged in said flow path such that the combustion gas returned back at an upper end of said furnace flue and lowered in said flow path flows across said reforming tube.

3. A fuel reforming apparatus wherein reforming tubes are accommodated in a flow path formed between an inner cylinder of a vessel and a furnace flue arranged in said inner cylinder, combustion gas generated in a combustor and raised up in said furnace flue being lowered in said flow path so as to reform source gas flowing in a reformer, characterized in that formed between said furnace flue and a guide cylinder accommodated in the furnace flue is a gap through which the combustion gas generated in the combustor for introduction forward an upper end of said flow path is raised, a helical plate being arranged in said flow path such that the combustion gas returned back at an upper end of said furnace flue and lowered in said flow path flows across said reforming tubes.
